(19) United States
(12) Patent Application Publication
(10) Pub. No.: US 2004/0081726 A1
(43) Pub. Date: Apr. 29, 2004

(54) Produce snack kit that enhances the appeal of produce to children

(76) Inventor: Thomas Andrew Fink, Kettering, OH (US)

Correspondence Address: THOMAS ANDREW FINK, 1050 WEST DOROTHY LANE, APARTMENT3, KETTERING, OH, 45409, US

(21) Appl. No.: 10/280,455

(22) Filed: Oct. 26, 2002

(51) Int. Cl. A23G 1/00

(52) U.S. Cl. 426/104

(57) ABSTRACT

A produce snack kit includes a plurality of shaped produce pieces which are shaped to allow arrangement into one or more predetermined arrangement goals, and a goal indication means for indicating the one or more predetermined arrangement goals. A user arranges the plurality shaped produce pieces into the one or more predetermined arrangement goals with the aid of the goal indication means. The invention may be embodied as methods or apparatus.

### BACKGROUND

Due to the pace and demands of the modern world, parents often seek foods that are easier and more convenient to prepare for their children. In fact, many foods require no preparation at all, for example snack foods. Snack foods are especially popular with children. Health organizations have warned that many of these foods are high in fat or sugar content, or simply low in nutritional value. Habitual consumption of these foods has been associated in part with health problems such as increases in childhood obesity.

In an attempt to promote healthier diets, health organizations have recommended that parents increase the amount of fruits and vegetables eaten in their children's diets. However, despite these recommendations from health organizations, many children do not eat the amount of fruits and vegetables recommended in their daily diet. Parents often find it difficult to persuade their children to eat more fruits and vegetables. In addition, preparing many fruits and vegetables for consumption by their children can be an inconvenient process for busy parents. As opposed to fruits and vegetables in their cooked state, fruits and vegetables in their raw state are most convenient for parents and also most nutritious for children.

Therefore, a need exists for an invention that conveniently allows parents to increase the appeal of raw fruits and vegetables to their children.

### SUMMARY

The word produce is often used to refer to raw fruits and vegetables. Therefore, for the sake of brevity, the word produce may be used here forth to mean raw fruits and vegetables.

The present invention satisfies the need for an invention that conveniently allows parents to increase the appeal of raw fruits and vegetables to their children. Accordingly, the present invention has several objects and advantages including:

(a). to provide a healthy snack food for children.

(b). to provide pre-washed, pre-packaged, raw fruits and vegetables suitable for convenient consumption by children.

(c). to present raw fruits and vegetables in a manner that is appealing to children.

(d). to improve the process of eating raw fruits and vegetables for children.

(e). to provide produce pieces that are joinable into a predetermined configuration.

(f). to provide a kit of components that allow a child to arrange a plurality of produce pieces into a predetermined arrangement goal.

(g). to provide added functionality to raw produce to increase its appeal to children.

(h). to associate enjoyable activities to the consumption of raw produce thereby improving a child's subjective attitude concerning the consumption of raw produce.

(i). to provide increased enjoyment for children while they eat raw produce.

(j). to provide a learning experience to children while they eat raw produce.

(k). to facilitate children in the process of learning letters and associated skills requiring the use of letters.

(l). to provide produce pieces with integrated joints that allow the produce pieces to be joined into a predetermined configuration, wherein the integrated joints are sufficient to deter separation due to mild forces associated with handling of the predetermined configuration.

The present invention does not require that all the objects and all the advantages need to be incorporated into every embodiment of the present invention.

The present invention teaches both apparatus and methods and thus can be embodied as apparatus or methods.

The produce snack kit of the present invention comprises a plurality of shaped produce pieces which are shaped to allow arrangement into one or more predetermined arrangement goals, and a goal indication means for indicating the one or more predetermined arrangement goals. A user arranges the plurality shaped produce pieces into the one or more predetermined arrangement goals with the aid of the goal indication means.

The produce snack kit of present invention can also include a package for the shaped produce pieces to protect them during shipping and handling. It can also include one or more additional produce pieces whose arrangement is not predetermined, whereby the user is allowed at least some freedom of arrangement.

The goal indication means for indicating the one or more predetermined arrangement goals can be any indicator or indicators that aid a user in arranging the produce pieces into the one or more predetermined arrangement goals. Examples of a goal indication means include a visual indicator of the produce pieces arranged into the one or more predetermined arrangement goals, a text description of the one or more predetermined arrangement goals, and corresponding characteristics of two or more of the produce pieces themselves. Examples of these characteristics include marking characteristics, size characteristics, and shape characteristics. Thus, by aiding the user in the arrangement process, the produce pieces themselves can serve as a goal indication means through the use of marking characteristics, size characteristics, or shape characteristics. Pre-assembling the plurality of produce pieces into the one or more predetermined arrangement goals, whereby a user disassembles and subsequently reassembles the pieces, can also provide the goal indication means.

The produce kit of the present invention teaches methods of enhancing the appeal of produce to children. A method of the present invention comprises determining a configuration of a plurality of produce pieces; determining joints to join the plurality of produce pieces into the configuration, wherein the joints are integrated with the plurality of produce pieces, the joints being sufficient to deter separation due to mild forces associated with handling of the configuration; and shaping the produce into the plurality of produce pieces with integrated joints; whereby the plurality of plurality of produce pieces with integrated joints can be joined into the configuration and handled by the children. The integrated joints can utilize frictional forces to deter separation of the plurality of produce pieces. Optionally, the configuration can include a movable joint.

### DRAWING FIGURES

These and other features, aspects, objects, and advantages of the present invention will become better understood with regard to the following description, appended claims, and accompanying drawings, where:

FIGS. 1 to 10 show various aspects of a preferred embodiment of the produce snack kit of the present invention.

FIG. 1 shows an exploded view of the shaped produce pieces.

FIG. 2 shows the shaped produce pieces joined into the predetermined configuration.

FIG. 3 shows a top view of the configuration of FIG. 2.

FIG. 4 shows a sectional view of the configuration of FIG. 3.

FIG. 4A shows an expanded view of the sectional view of FIG. 4.

FIG. 5 shows a front view of a plastic bag having a drawing of the predetermined arrangement goal printed on the plastic bag.

FIG. 6 shows a sectional view of an alternative predetermined configuration.

FIG. 7 shows a top view of an alternative leg produce piece.

FIG. 8 shows a sectional view of the leg produce piece of FIG. 7.

FIG. 9 shows another sectional view of the leg produce piece of FIG. 7.

FIG. 10 shows colored markings on the leg produce piece and the body produce piece.

FIGS. 11 to 17 show various views of shaping procedures and shaping tools used in shaping the produce pieces.

FIG. 11 shows a piece of produce and a cutting tool ready for cutting.

FIG. 12 shows the cutting tool pressed through the piece of produce. FIG. 13 shows the piece of produce shown in FIGS. 11 and 12 having a shape cut from its center and a relief cut.

FIG. 14 shows a drill bit after drilling a hole in a sectional view of a piece of produce.

FIG. 15 shows a top view of the cutting tool shown in FIGS. 11 and 12.

FIG. 16 shows a sectional view of the cutting tool of FIG. 15.

FIG. 17 shows another sectional view of the cutting tool of FIG. 15.

FIGS. 18A to 20 show various aspects of a produce snack kit embodying features of the present invention.

FIG. 18A shows a front view of the first arrangement goal of the produce snack kit. All the produce pieces are properly assembled except for the left leg produce piece.

FIG. 18B shows a front view of the second arrangement goal of the produce snack kit.

FIG. 19 is a sectional view of the left arm produce piece.

FIG. 20 shows a front view of a plastic bag having a drawing of the first arrangement goal and a text description of the second arrangement goal printed on the plastic bag.

FIGS. 21 to 31 show various views of shaping procedures and shaping tools used in shaping the produce pieces.

FIG. 21 shows a knife making a perpendicular cut on a carrot.

FIG. 22 shows a perpendicular slice cut from the carrot of FIG. 21.

FIG. 23 shows a knife making an angled cut on a carrot.

FIG. 24 shows an angled slice cut from the carrot of FIG. 23.

FIG. 25 shows a top view of the perpendicular carrot slice of FIG. 22.

FIG. 25A shows the carrot slice of FIG. 25 having a shape cut from its center.

FIG. 25B shows the shape cut from the center of the slice of FIG. 25A.

FIG. 26 shows a top view of the angled carrot slice of FIG. 24.

FIG. 26A shows the angled carrot slice of FIG. 26 having a shape cut from its center.

FIG. 26B shows the shape cut from the center of the slice of FIG. 26A.

FIG. 27 shows a piece of produce and a cutting tool ready for cutting.

FIG. 28 shows the cutting tool pressed through the piece of produce.

FIG. 29A shows the piece of produce shown in FIGS. 27 and 28 having a shape cut from its center.

FIG. 29B shows the shape cut from the center of the piece of produce of FIG. 29A.

FIG. 30 shows a top view of the cutting tool shown in FIGS. 27 and 28.

FIG. 31 shows a sectional view of the cutting tool of FIG. 30.

FIGS. 32 and 33 show various aspects of a produce snack kit embodying features of the present invention.

FIG. 32 shows a front view of a plastic bag having a drawing of a cup printed on the plastic bag.

FIG. 33 shows the produce pieces arranged into the word cup.

### REFERENCE NUMERALS USED IN DRAWINGS

| | | | |
|---|---|---|---|
| 101 | produce pieces | 102 | predetermined produce |
| | | | configuration |
| 102′ | alternative predetermined produce | | |
| | configuration | | |
| 103 | head produce piece | 105 | neck produce piece |
| 107 | tail produce piece | 107′ | different diameter tail |
| | | | produce piece |
| 107″ | tail produce piece with movable | 108 | gap |
| | joint | | |
| 109 | body produce piece | | |
| 109′ | body produce piece having | | |
| | different diameter holes | | |
| 110 | saddle produce piece | 111 | leg produce piece |
| 111′ | different diameter leg produce | 112 | sloping portion of hole |
| | piece | | |
| 113 | drilled holes | 113′ | different diameter tail |
| | | | hole |
| 113″ | different diameter leg hole | 115 | plastic bag |
| 117 | drawing | 119 | upper movable leg |
| | | | produce piece |
| 121 | lower movable leg produce piece | 123 | pin produce piece |
| 124 | movable joint | 125 | blue marking |
| 127 | blue marking corresponding to 125 | 128 | produce piece |
| 128A | produce piece 128 with shape cut | | |
| | from its center and relief cut | | |
| 128B | shape cut from center of produce | | |
| | piece 128A | | |
| 129 | cutting tool | 130 | produce piece |
| 131 | handle | 132 | drill bit |
| 133 | relief cutting blade | 134 | relief cut |
| 135 | cutting edge | | |
| 201 | produce pieces almost completely | | |
| | arranged into first predetermined | | |
| | arrangement goal | | |
| 202 | produce pieces arranged into | | |
| | second predetermined arrangement | | |
| | goal | | |
| 203 | head produce piece | 204 | fish tail produce piece |
| 205 | arm produce piece | 207 | right leg produce piece |
| 208 | produce piece | 209 | left leg produce piece |
| 211 | plastic bag | 213 | drawing |
| 214 | text | 215 | knife |
| 217 | carrot | 219 | perpendicular slice |
| 219A | perpendicular slice 219 with | | |
| | shape cut from its center | | |
| 219B | shape cut from center of | | |
| | perpendicular slice 219A | | |
| 221 | angled slice | | |
| 221A | perpendicular slice 221 with shape | | |
| | cut from its center | | |
| 221B | shape cut from center of | | |
| | perpendicular slice 221A | | |
| 223 | cutting tool | 225 | produce piece |
| 225A | produce piece 225 with shape cut | | |
| | from its center | | |
| 225B | shape cut from center of produce | | |
| | piece 225A | | |
| 301 | plastic bag | 303 | drawing |
| 305 | produce pieces | | |
| 307 | produce pieces arranged into the | | |
| | predetermined arrangement goal | | |

### DESCRIPTION

In order to clearly illustrate features, aspects, objects, and advantages of the present invention, descriptions of three embodiments of the present invention are provided.

The preferred embodiment of the produce snack kit of the present invention comprises a plurality of shaped produce pieces which are shaped to allow arrangement into one or more predetermined arrangement goals, and a goal indication means for indicating the one or more predetermined arrangement goals. In this embodiment, the produce pieces are shaped such that they join into a predetermined, three-dimensional configuration. The goal indication means is a visual indicator such as a drawing.

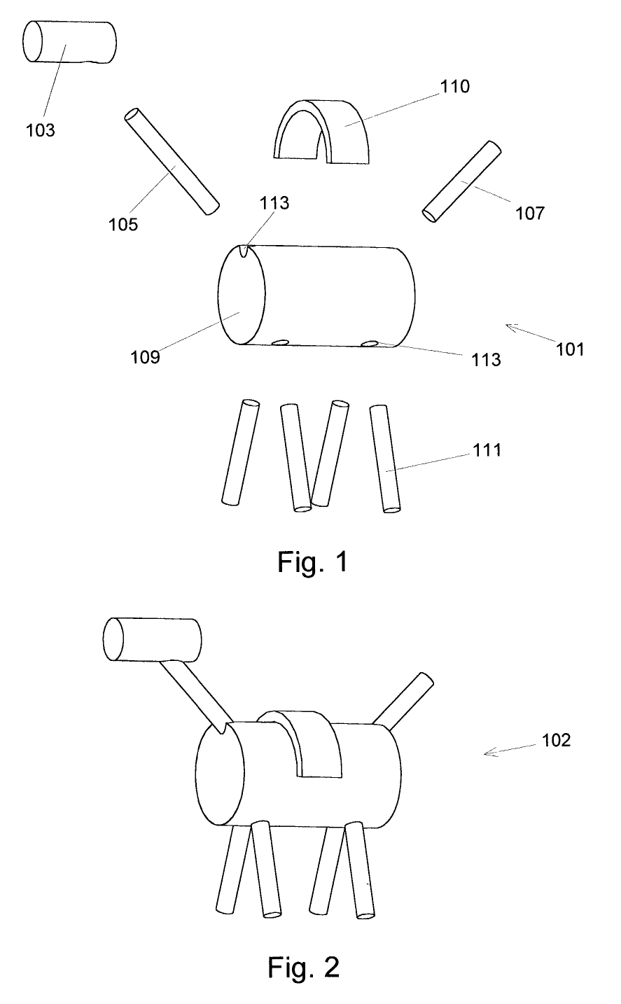

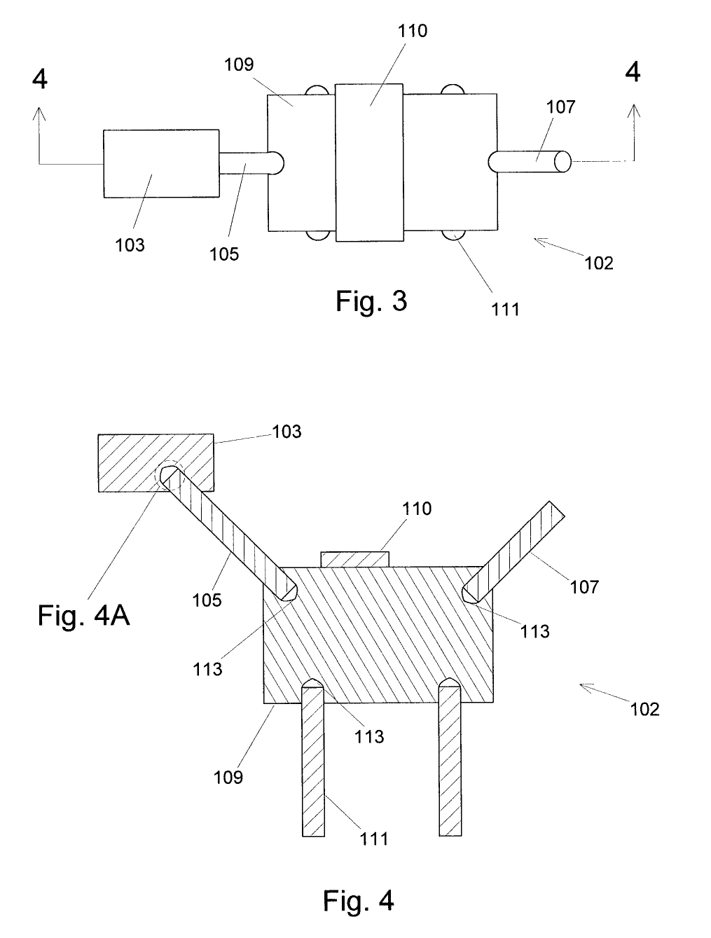

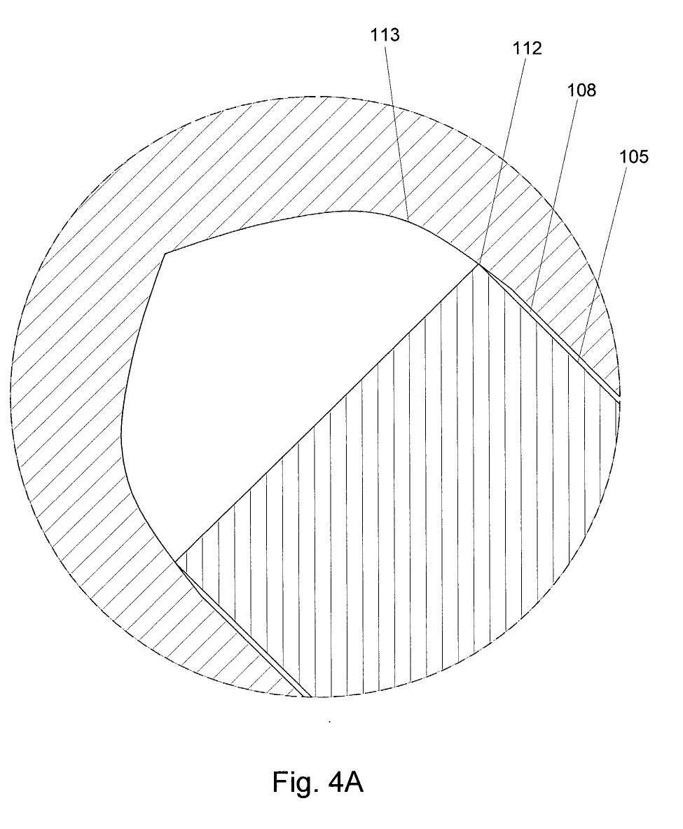

An example of this preferred embodiment is illustrated in FIGS. 1 to 10. FIG. 1 shows an exploded view of a plurality of shaped produce pieces 101. As shown in FIG. 2, these produce pieces are shaped to allow them to be joined into a three-dimensional configuration 102. This three-dimensional configuration 102 is the predetermined arrangement goal. FIG. 3 shows a top view of the three-dimensional configuration of FIG. 2. FIG. 4 shows a sectional view of the configuration.

Referring to FIGS. 1 to 4, the plurality of produce pieces include a head produce piece 103, a neck produce piece 105, a tail produce piece 107, a body produce piece 109, a saddle produce piece 110, and four leg produce pieces 111. The head produce piece and the body produce piece have holes 1 13. These holes allow the appropriate produce pieces to be inserted in order to join the produce pieces into the predetermined configuration. The neck produce piece is inserted into the hole in the head produce piece and the appropriate hole in the body produce piece; thereby joining these three produce pieces. The tail produce piece is inserted into the appropriate hole in the body produce piece; thereby joining these two produce pieces. The four leg produce pieces are inserted into the appropriate holes in the body produce piece; thereby joining these five produce pieces. The saddle produce piece can be placed in a many positions along the top of the body. Therefore, the position of the saddle produce piece is not predetermined. This allows the user some freedom of arrangement.

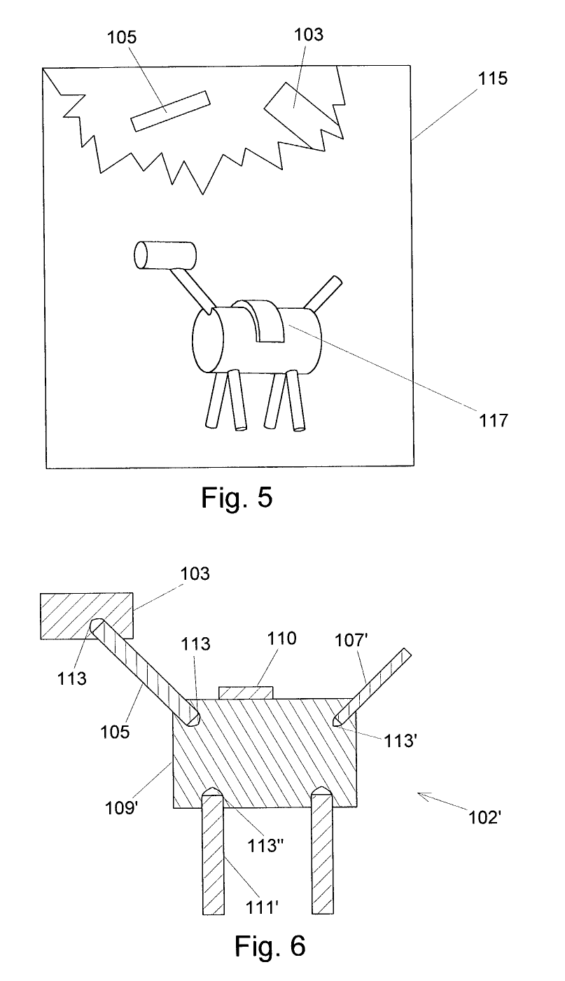

As shown in FIG. 5, a plastic bag 115 is provided to protect and isolate the produce pieces during shipping and handling. FIG. 5 shows a broken-out section of the plastic bag revealing two 103, 105 of the plurality of produce pieces stored inside the bag. A drawing of the predetermined arrangement goal 117 is printed on the plastic bag.

The plastic bag is opened and the produce pieces are removed from the plastic bag. The child uses the drawing of the predetermined arrangement goal printed on the plastic bag to aid in joining the produce pieces. The child can then play with the resulting three-dimensional configuration and subsequently eat the produce pieces as a healthy snack. Thus, use of the present invention enhances the appeal of produce to children. Eating raw produce is recommended by many health organizations to improve children's diets.

Optional and alternative features are shown in FIGS. 6 to 10. A sectional view of an alternative three-dimensional configuration 102′ is shown in FIG. 6. This alternative three-dimensional configuration illustrates an alternative goal indication means. The diameters of the tail produce piece 107′, the leg produce pieces 111′, and the matching holes 103′, 103″ in the body produce piece 109′ in this alternative configuration 102′ have been changed from those in the previously described configuration 102. This gives the neck, leg, and tail produce pieces different diameters. Because of the diameter differences, joining of all the produce pieces results exclusively in the predetermined arrangement goal. Therefore, these changes in diameter aid a user in assembling the produce pieces into the predetermined arrangement goal. This use of different size-characteristics of the produce pieces can be used as an alternative or in accompaniment to the drawing 117 as a means for indicating the predetermined arrangement goal.

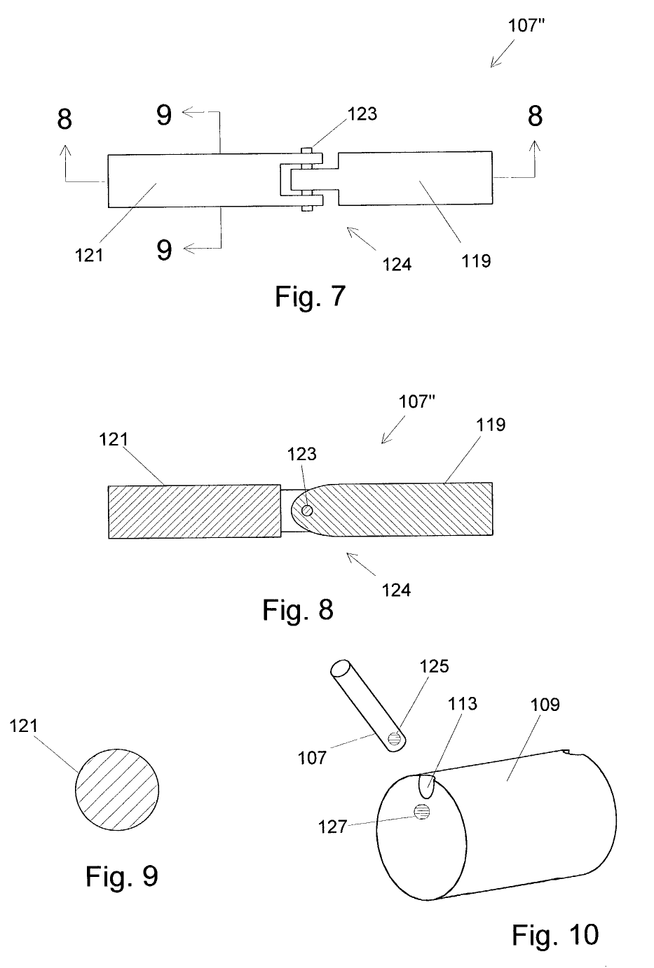

FIGS. 7 to 9 show views of an alternative tail produce piece 107″. This tail produce piece has a movable pin joint 124. The tail produce piece includes an upper leg produce piece 119, a lower leg produce piece 121, and a pin produce piece 123. The pin produce piece holds the upper and lower leg produce pieces together and allows movement of these two produce pieces relative to each other; this creates a moveable joint.

FIG. 10 shows yet another possible alternative goal indication means. The colored mark 125 on the tail produce piece 107 corresponds to the colored mark 127 on the body produce piece 109. These corresponding markings can aid the user in assembling the produce pieces into the predetermined arrangement goal. The hatch pattern of the markings is intended to show blue markings. The markings are made using an edible marking substance such as food coloring. Pre-assembling the plurality of produce pieces into the three-dimensional configuration 102, whereby a user disassembles and subsequently reassembles the pieces, can also provide the goal indication means.

Shaping the produce pieces generally comprises cutting pieces of produce, cutting shapes from these pieces, and drilling holes. Freshly harvested vegetables are cleaned and undesirable parts of the vegetables are trimmed.

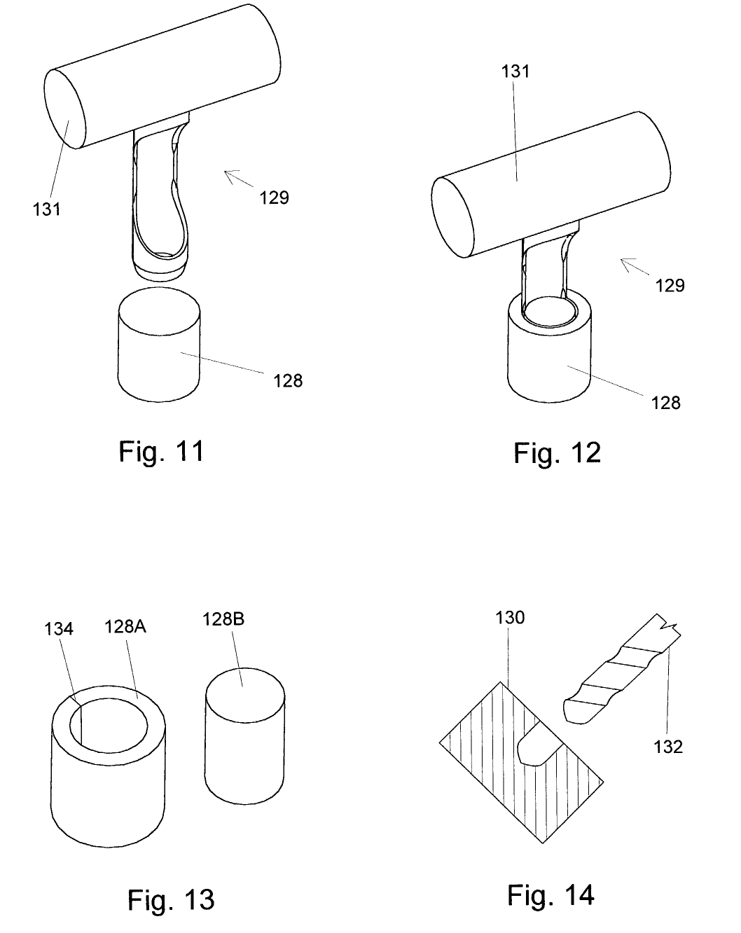

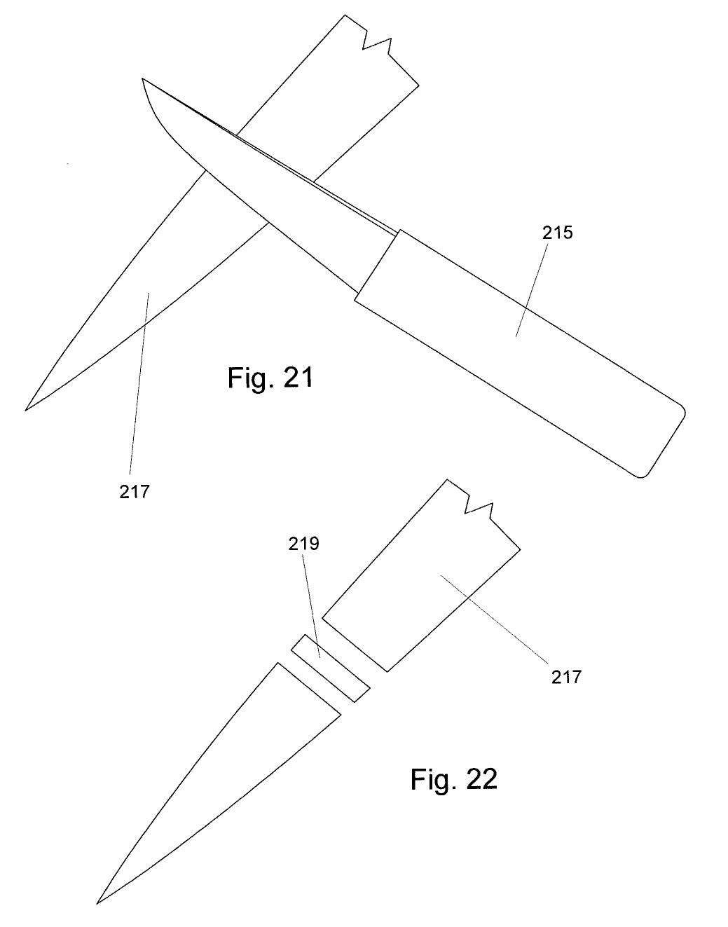

FIGS. 11 to 17 and FIG. 21 show various views of shaping procedures and shaping tools used in shaping the produce pieces. The preferred types of produce include carrots, kohlrabi, apples, cauliflower stems, and broccoli stems. First the produce is cut to length. As shown in FIG. 21, produce is cut using a knife 215. Then, shapes are cut from these pieces. FIG. 11 shows a piece of produce 128 and a cutting tool 129 ready for cutting. FIG. 12 shows the cutting tool pressed through the piece of produce. FIG. 13 shows the result of the cutting: a cut piece 128B and the remaining part of the original produce piece 128A.

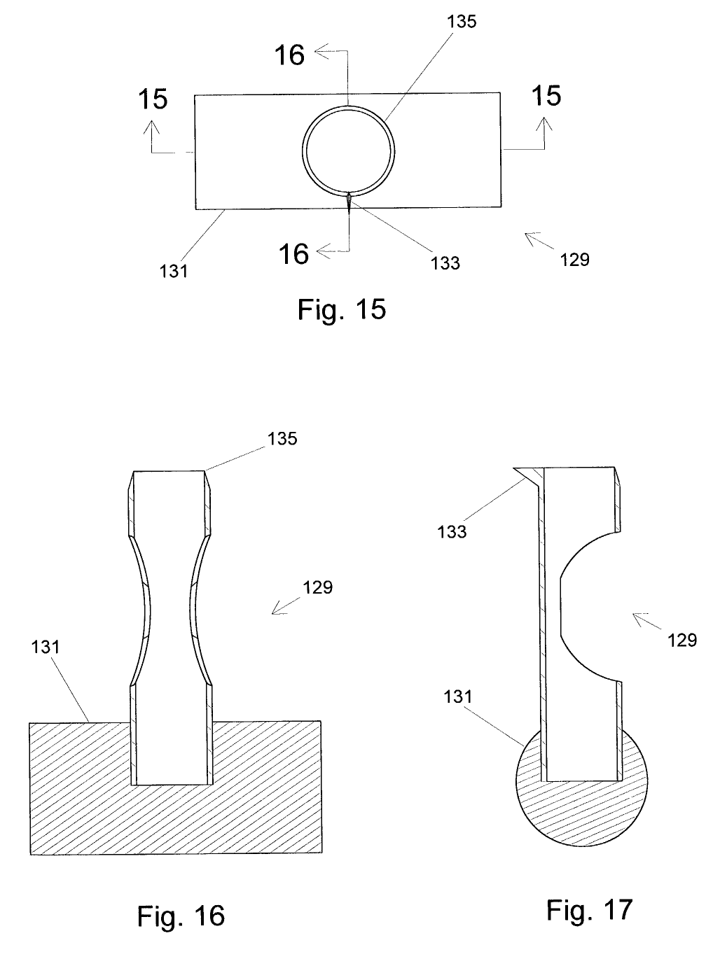

FIGS. 15 to 17 show various views of the cutting tool used in FIGS. 11 and 12. FIG. 15 shows a top view of the cutting tool shown. FIG. 16 shows a sectional view of the cutting tool of FIG. 15. FIG. 17 shows another sectional view of the cutting tool of FIG. 15. The cutting tool includes a handle 131, a relief cutting-blade 133, and a cutting edge 135. Using the handle, a user pushes the cutting tool through the produce. The cutting edge cuts the desired shape from the produce. The relief cutting-blade provides a relief cut 134 in the produce to lessen the pushing-force applied to the handle. The resulting relief cut 134 is shown in FIG. 13. The saddle produce piece 110 shown in FIG. 2 is made by cutting produce piece 128A in half aligned with the relief cut.

Holes in the body produce piece and head produce piece are made using a drill bit. FIG. 14 shows a sectional view of a piece of produce 130 after being drilled by a drill bit 132. FIG. 4A shows an expanded view of the hole drilled in the head produce piece of FIG. 4. As shown in FIG. 4A, the diameter of the neck produce piece 105 is slightly smaller than the diameter of the hole 113. This difference in diameters results in a gap 108 between the neck produce piece and the hole drilled in the head produce piece. This gap allows easy insertion of the neck produce piece into the hole. As the neck produce piece is inserted into the hole, it contacts the sloping portion of the hole 112. By pushing the neck produce piece further into the hole, the neck produce piece is wedged against the hole. The resulting frictional forces between the neck produce piece and the hole deter separation due to mild forces associated with handling.

Another embodiment of the produce snack kit of the present invention comprises a plurality of shaped produce pieces which are shaped to allow arrangement into one or more predetermined arrangement goals, and a goal indication means for indicating the one or more predetermined arrangement goals. In this embodiment, the produce pieces are shaped into interlocking pieces that are arranged into one or more arrangement goals. The goal indication means for each arrangement goal is a visual indicator such as a drawing, text description, or shape characteristics of two or more of the interlocking produce pieces.

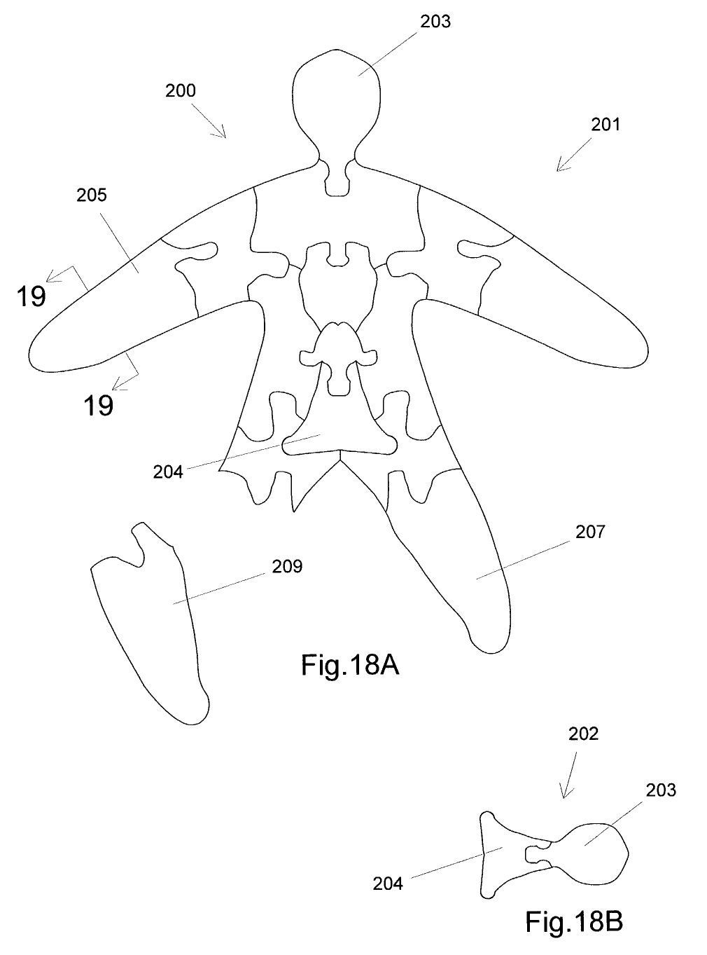

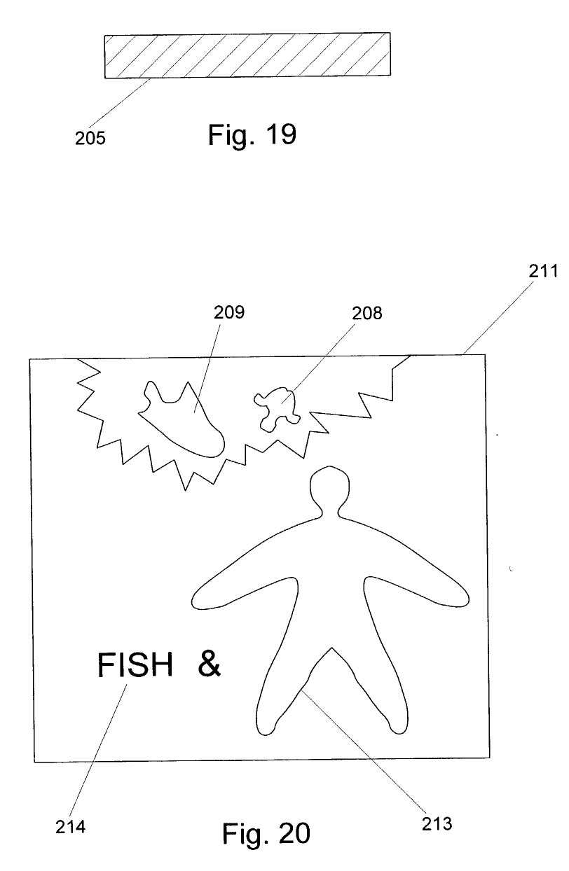

An example of this embodiment is shown in FIGS. 18A to 20. The produce kit includes fifteen produce pieces 200 shaped into interlocking pieces. As shown in FIGS. 18A and 18B, these fifteen interlocking produce pieces arrange into a first arrangement goal resembling a human 201 and two of these interlocking vegetable pieces 203, 204 arrange into a second arrangement goal resembling a fish 202. FIG. 18A shows all the interlocking produce pieces arranged into the first arrangement goal except the left leg produce piece 209. The left leg produce piece 209 arranges in similar fashion to the right leg produce piece 207, resulting in a symmetrical shape. The FIG. 19 shows a cross section of the left arm produce piece 205. All the produce pieces have the same thickness.

As shown in FIG. 4, a plastic bag 211 is provided to protect and isolate the produce pieces during shipping and handling. FIG. 4 shows a broken-out section of the plastic bag revealing two 208, 209 of the plurality of produce pieces stored inside the bag. A drawing of the predetermined arrangement goal resembling a human 213 and the word fish 214 are printed on the plastic bag.

The plastic bag is opened and the interlocking produce pieces are removed from the plastic bag. The child uses the drawing of the human and the word fish on the plastic bag to aid in the arrangement of the interlocking produce pieces into the human shape and the fish shape. The child eats the produce pieces as a healthy snack. Eating raw produce is recommended by many health organizations to improve children's diets.

Alternatively, the shape characteristics of the head produce piece 203 and the tail produce piece 204 can serve as the goal indication means. This could be accomplished by first replacing the word fish on the plastic bag by a question mark that suggests another arrangement goal but provides no aid in assembly, then allowing a child to use the shape characteristics of the head and tail produce pieces as the aid in assembly. The shape characteristics of the head produce piece and the tail produce piece allow them to only interlock into the human shape and the fish shape. Thus, the shape characteristics of the head produce piece and the tail produce piece aid a child in assembly into the fish arrangement goal.

Shaping the produce pieces generally comprises slicing produce, and cutting shapes from the slices. Freshly harvested vegetables are cleaned and undesirable parts of the vegetables are trimmed.

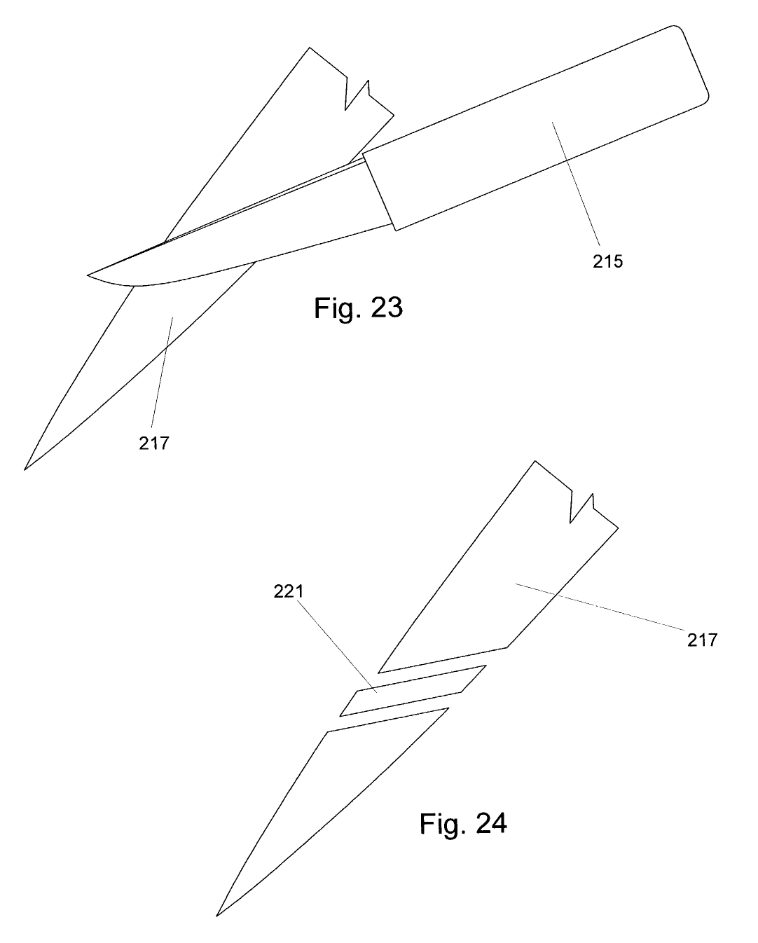

FIGS. 21 to 31 show various views of shaping procedures and shaping tools used in shaping the produce pieces. The produce used in making the plurality of produce pieces are carrots 217. The plurality of produce pieces are shaped by first slicing a carrot with a knife 215. FIGS. 21 and 22 show a perpendicular slice 219 made perpendicular to the length of the carrot, and FIGS. 23 and 24 show an angled slice 221 made at an angle closer to parallel to the length of the carrot. By slicing the carrot at an angle closer to parallel to the length of the carrot, slices are elliptically shaped rather than circularly shaped. The elliptically shaped slice offers increased length along its major axis. This is useful for making produce pieces with a dimension greater than the diameter of a perpendicular carrot slice.

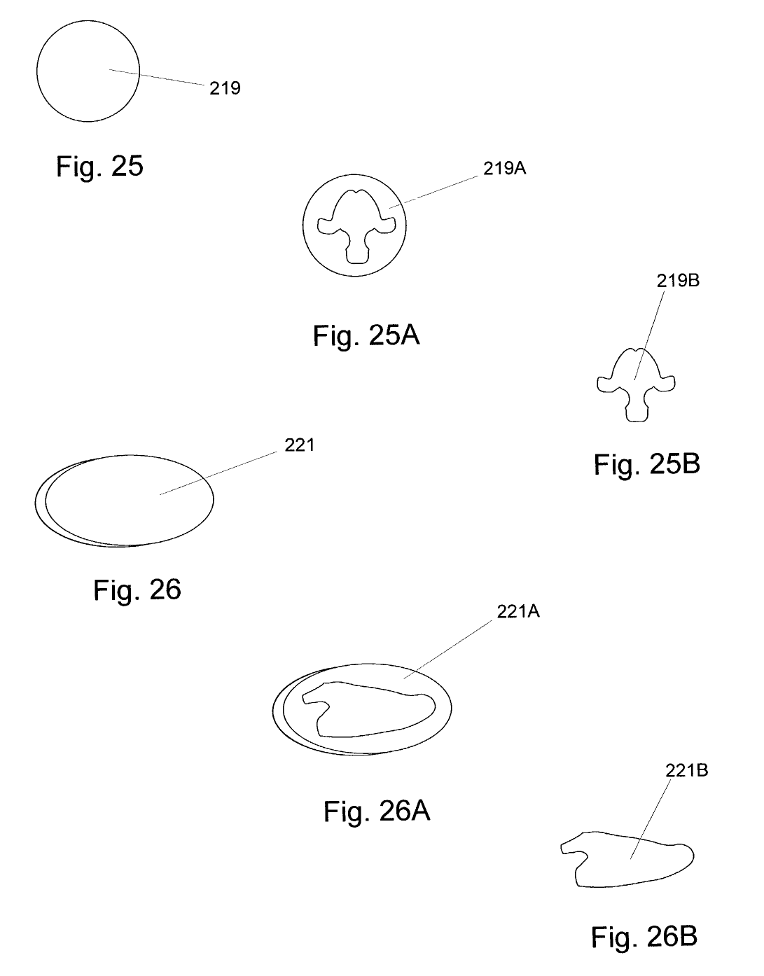

For example, FIGS. 25 to 25B show a produce piece made from the perpendicular carrot slice of FIG. 22, and FIGS. 26 to 26B show a produce piece made from the angled carrot slice of FIG. 24. FIG. 25 shows a top view of the perpendicular carrot slice 219 of FIG. 22. FIGS. 25B shows a produce piece 219B cut from the perpendicular carrot slice FIG. 25A shows the perpendicular carrot slice with the cut produce piece removed 219A. FIG. 26 shows a top view of the angled carrot slice 221 of FIG. 24. FIGS. 26B shows a produce piece 221B cut from the angled carrot slice. FIG. 26A shows the angled carrot slice with the cut produce piece removed 221A. Produce piece 221B has a dimension that exceeds the diameter of the perpendicular carrot slice; therefore the angled slice is used for cutting piece 221B.

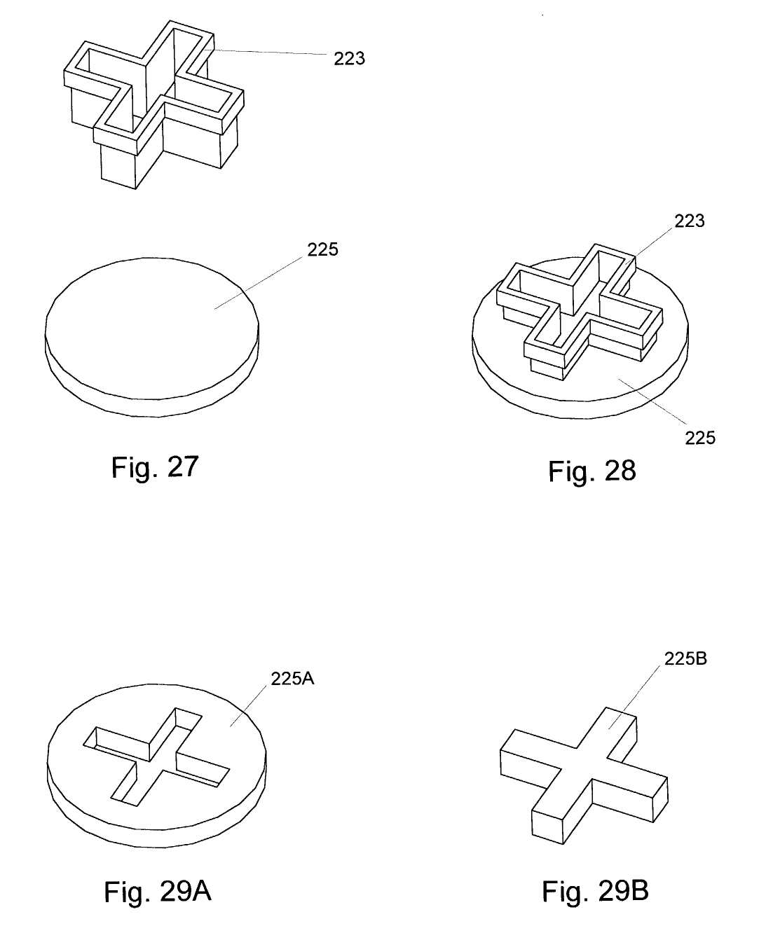

The cutting procedure used to make the produce pieces is illustrated in FIGS. 27 to 31. FIG. 27 shows a piece of produce 225 and a cutting tool 223 ready for cutting. FIG. 28 shows the cutting tool pressed through the piece of produce. FIG. 29A shows the piece of produce shown in FIGS. 27 and 28 having a shape cut from its center 225A. FIG. 29B shows the shape 225B cut from the center of the piece of produce of FIG. 29A.

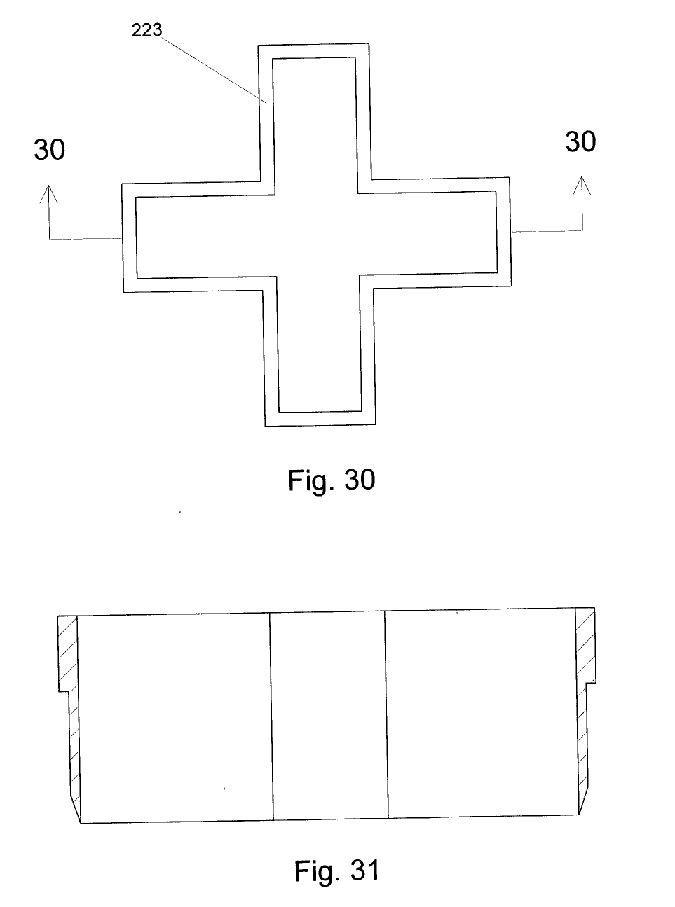

FIG. 30 shows a top view of the cutting tool 223 shown in FIGS. 27 and 28. FIG. 31 shows a sectional view of the cutting tool of FIG. 30.

Yet another embodiment of the produce snack kit of the present invention comprises a plurality of shaped produce pieces which are shaped to allow arrangement into one or more predetermined arrangement goals, and a goal indication means for indicating the one or more predetermined arrangement goals. In this embodiment, the produce pieces are shaped into letters and the one or more predetermined arrangement goals is one or more words. The goal indication means is a visual indicator such as drawing corresponding to each word.

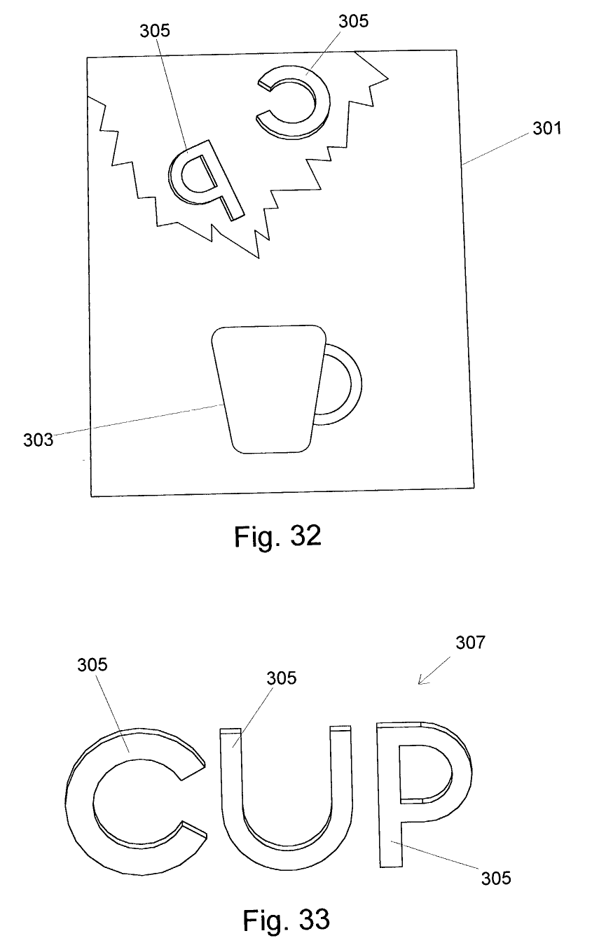

An example of this embodiment is shown in FIGS. 32 and 33. The produce kit comprises a plurality of produce pieces shaped into letters 305 that allow a child to spell the word cup 307, a plastic bag 301 to protect the produce pieces during shipping and handling, and a drawing of a cup 303 is printed on the plastic bag.

The plastic bag is opened and the produce letters are removed from the plastic bag. The child uses the drawing of the cup on the plastic bag to aid in the arrangement of the produce letters into the word cup. The child eats the produce pieces as a healthy snack.

Eating raw produce is recommended by many health organizations to improve children's diets.

The letters are made using the shaping procedures described in making the preceding embodiment.

The shaping procedures described above are preferred for their simplicity. However, many other shaping procedures can be used in making the present invention including stamping, cutting, grinding, turning, and polishing. If speed and production need to be increased, shaping procedures can be mechanized. Therefore, the particular shaping procedures presented herein are not essential for practicing the present invention.

Although the description above contains many specificities, these should not be construed as limiting the scope of the invention but as merely providing illustrations of some of the presently preferred embodiments of this invention. For example, a rigid plastic container can be used instead of a plastic bag. A different arrangement goal can be used instead of the specific arrangement goals described above. A different style of joint can be used instead of the specific joints described above.

Thus the scope of the invention should be determined by the appended claims and their legal equivalents, rather than by the many specific examples provided herein for illustration.

What is claimed is:

1. A produce snack kit comprising:
a plurality of produce pieces,
the produce pieces being shaped to allow arrangement into one or more predetermined arrangement goals; and
a goal indication means for indicating the one or more predetermined arrangement goals;
whereby a user arranges the plurality of shaped produce pieces into the one or more predetermined arrangement goals with the aid of the goal indication means.

2. The produce snack kit of claim 1 further comprising one or more additional produce pieces whose arrangement is not predetermined; whereby the user is allowed at least some freedom of arrangement.

3. The produce snack kit of claim 1 wherein the goal indication means is one or more corresponding characteristics of two or more of the produce pieces.

4. The produce snack kit of claim 3 wherein the corresponding characteristics include shape characteristics.

5. The produce snack kit of claim 3 wherein the corresponding characteristics include size characteristics.

6. The produce snack kit of claim 3 wherein the corresponding characteristics include marking characteristics.

7. The produce snack kit of claim 1 further comprising a package to protect the plurality of produce pieces during shipping and handling.

8. The produce snack kit of claim 7 wherein the goal indication means is a visual indicator of the one or more predetermined arrangement goals on the package.

9. A method for enhancing the appeal of produce to children, the method comprising:
predetermining one or more arrangement goals for a plurality of produce pieces;
shaping the plurality of produce pieces to allow arrangement into the one or more predetermined arrangement goals; and
providing a goal indication means for indicating the one or more predetermined arrangement goals;
whereby the child arranges the shaped produce pieces into the one or more predetermined arrangement goals with the aid of the goal indication means.

10. The method of claim 9 further comprising one or more additional produce pieces whose arrangement is not predetermined; whereby the user is allowed at least some freedom of arrangement.

11. The method of claim 9 wherein the goal indication means is one or more corresponding characteristics of two or more of the produce pieces.

12. The method of claim 11 wherein the corresponding characteristics include shape characteristics.

13. The method of claim 11 wherein the corresponding characteristics include size characteristics.

14. The method of claim 111 wherein the corresponding characteristics include marking characteristics.

15. The method of claim 9 further comprising a package to protect the plurality of produce pieces during shipping and handling.

16. The method of claim 15 wherein the goal indication means is a visual indicator of the one or more predetermined arrangement goals on the package.

17. A method of enhancing the appeal of produce to children, the method comprising:
determining a configuration of a plurality of produce pieces;
determining joints to join said plurality of produce pieces into said configuration, wherein said joints are integrated with said plurality of produce pieces, said joints being sufficient to deter separation due to mild forces associated with handling of said configuration; and
shaping said produce into the plurality of produce pieces with integrated joints;
whereby said plurality of plurality of produce pieces with integrated joints can be joined into said configuration and handled by said children.

18. The method of claim 17 wherein said integrated joints utilize frictional forces to deter separation of said plurality of produce pieces.

19. The method of claim 17 wherein said integrated joints include a movable joint.
